(19) United States
(12) Patent Application Publication
(10) Pub. No.: US 2015/0304229 A9
(43) Pub. Date: Oct. 22, 2015

(54) Method and system for allocating receiving resources in a gateway server

(71) Applicants: Gary Robert Gutknecht, Noblesville, IN (US); Barry Jay Weber, Carmel, IN (US); Andrew Kent Flickner, Zionsville, IN (US)

(72) Inventors: Gary Robert Gutknecht, Noblesville, IN (US); Barry Jay Weber, Carmel, IN (US); Andrew Kent Flickner, Zionsville, IN (US)

(21) Appl. No.: 11/821,893

(22) Filed: Jun. 26, 2007

Related U.S. Application Data
(63) Continuation of application No. PCT/US2005/035225, filed on Sep. 30, 2005.
(60) Provisional application No. 60/641,880, filed on Jan. 5, 2005.

(51) Int. Cl. H04L 12/911; H04L 29/06; H04L 12/26

(52) U.S. Cl. CPC H04L 47/70; H04L 43/08; H04L 65/103

(57) ABSTRACT

The disclosed embodiments relate to a method and apparatus for allocating resources in an efficient manner in a gateway service device. The apparatus includes of a gateway server or head end unit connected to a plurality of end user terminals. The gateway server contains a controller for managing the allocation of receiving resources used for providing services to the end user terminals. The method includes receiving a service request, comparing the request to services already in use and, if a match is found, providing an updated data stream containing new information regarding the service to the end user terminals.

This application claims the benefit under 35 U.S.C.§ 119 of a provisional application 60/641,880 filed in the United States on Jan. 5, 2005.

### FIELD OF THE INVENTION

The present invention is directed towards allowing a gateway server containing a plurality of receiving resources to allocate these resources dynamically to clients based on a resource conservation method.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

As most people are aware, satellite television systems, such as DirecTV, have become much more widespread over the past few years. In fact, since the introduction of DirecTV in 1994, more than twelve million American homes have become satellite TV subscribers. Most of these subscribers live in single-family homes where satellite dishes are relatively easy to install and connect. For example, the satellite dish may be installed on the roof of the house.

Many potential subscribers, however, live or temporarily reside in multi-dwelling units (“MDUs”), such as hotels or high-rise apartment buildings. Unfortunately, there are additional challenges involved with providing satellite TV services to the individual dwelling units within an MDU. It may be impractical and/or extremely expensive to provide and connect one satellite dish per dwelling. For example, in a high-rise apartment building with one thousand apartments, it may be impractical to mount one thousand satellite dishes on the roof of the building. Some conventional systems have avoided these issues by converting the digital satellite television signal into an analog signal that can be transmitted via a single coaxial cable to a plurality of dwellings. These systems, however, offer limited channels, have reduced quality compared to all-digital systems, and cannot provide the satellite TV experience to which users who live in single family homes are accustomed.

Distribution of services such as satellite signals directly to individual dwellings in an MDU would permit the ability to provide the experience similar to single family home users but can also involve complications. For instance, distribution of satellite signals from a dish requires special distribution equipment and wiring, which is often not found in MDU establishments. The cost to retrofit the establishment may be significant.

It is also possible to create a system whereby each dwelling unit receives services using dedicated resources for receiving signals where these resource are located remotely. For example, the main tuning functions could be located in a central control room and a unique signal or service sent to each dwelling unit. This connection could be made using Ethernet or co-axial cable that could be distributed throughout the building. Typically for systems to distribute video content, each end user must have its own dedicated tuning and decoding circuit. This can be costly and inefficient, particularly for large MDU establishments.

Therefore it is desirable to develop a system that may limit the number of circuits used as receiving resources that may reside in a central location. Furthermore, in order to help maximize operational performance and provide the lowest cost, a solution for managing tuning resources that allows for using the fewest number of tuning resources in the system is desirable.

### SUMMARY OF THE INVENTION

The disclosed embodiments relate to a method and apparatus for allocating receiving resources. The apparatus includes a head-end or gateway server unit that receives a plurality of signals and outputs a series of data streams that are provided to a plurality of STBs located within a facility such as a MDU. The apparatus further includes a set of receiving resources within the head-end unit along with a receiver for receiving request signals and a controller for processing the request signals and managing the use of the receiving resources. The method includes a process for allocating the receiving resources used by the head end unit to provide the services requested by the STBs. The method further includes receiving a request signal for a service from a STB, comparing this request for a service with services already being provided, and establishing a shared use of one of the receiving resources already providing the requested service if the a match is found between the newly requested service and a currently provided service.

### BRIEF DESCRIPTION OF THE DRAWINGS

Advantages of the invention may become apparent upon reading the following detailed description and upon reference to the drawings in which:

FIG. 1 is a block diagram of an exemplary satellite television over IP system of the present invention;

FIG. 2 is another embodiment of the exemplary satellite television over IP system illustrated in FIG. 1;

FIG. 3 is a block diagram of an exemplary satellite gateway of the present invention; and

FIG. 4 is a flow chart of an exemplary method for allocating receiving resources such as tuners in a satellite gateway of the present invention.

The characteristics and advantages of the present invention may become more apparent from the following description, given by way of example.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

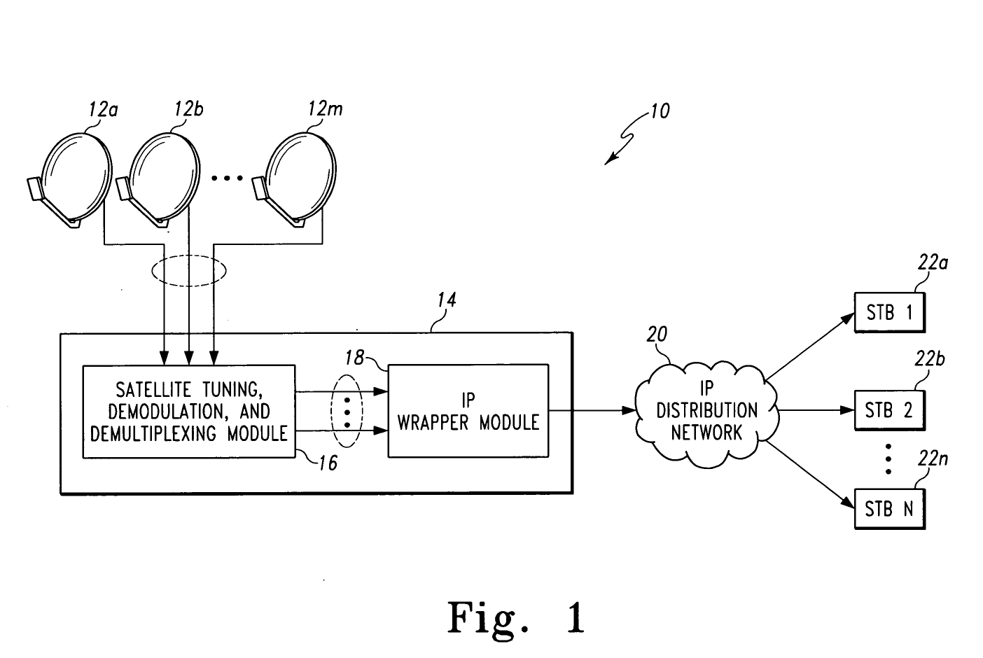

Turning initially to FIG. 1, a block diagram of an exemplary satellite television over IP system in accordance with one embodiment is illustrated and generally designated by a reference numeral 10. As illustrated, the system 10 may include one or more satellite dishes 12a through 12m, a head-end unit or gateway server, such as a satellite gateway 14, an IP distribution network 20, and one or more set top boxes (“STBs”) 22a through 22n which serve as end user devices. Those of ordinary skill in the art, however, will appreciate that the embodiment of the system 10 illustrated in FIG. 1 is merely one potential embodiment of the system 10. As such, in alternate embodiments, the illustrated components of the system 10 may be rearranged or omitted or additional components may be added to the system 10. For example, with minor modifications, the system 10 may configured to distributed non-satellite video and audio services.

The satellite dishes 12a-12m may be configured to receive video, audio, or other types of television-related data that is transmitted from satellites orbiting the earth. As will be described further below, in one embodiment the satellite dishes 12a-12m are configured to receive DirecTV programming over KU band from 10.7 to 12.75 Gigahertz (“GHz”). In alternate embodiments, however, the satellite dishes 12a-12m may be configured to receive other types of direct broadcast satellites (“DBS”) or television receive-only (“TVRO”) signal, such as Dish Network signals, ExpressVu signals, StarChoice signals, and the like. In still other non-satellite based systems, the satellite dishes 12a-12m may be omitted from the system 10.

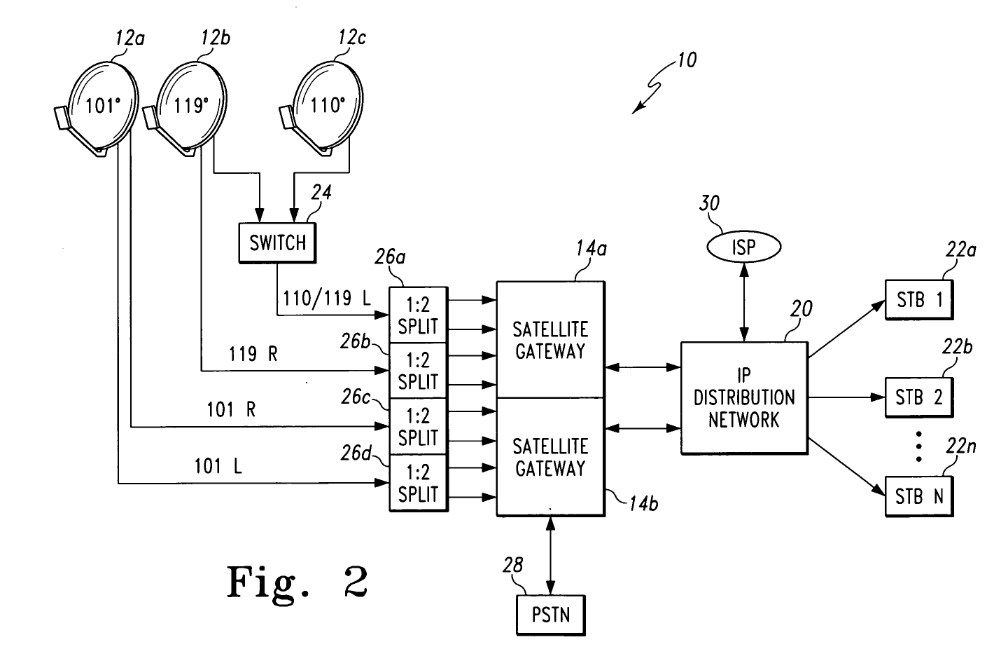

In one embodiment, a low noise-block converter (“LNC”) within the satellite dishes 12a-12m receives the incoming signal from the earth-orbiting satellite and converts these incoming signals to a frequency in the L band between 950 and 2150 Megahertz (“MHz”). As will be described in further detail below with regard to FIG. 2, each of the satellite dishes 12a-12m may be configured to receive one or more incoming satellite TV signals on a particular frequency (referred to as a transponder) and with a particular polarization and to convert these satellite signals to L band signals or transport streams, where each L band signal or transport stream may itself represent a transport stream for one program, often referred to as one of a set of Single Program Transport Streams (SPTS), or may represent multiple transport streams multiplexed together, referred to as a Multiple Program Transport Stream (MPTS). Each program stream in turn may represent an audio and/or video signal. Additionally each one of the SPTS may include a form of identifier, such as a Program Identifier (PID), which can be used to differentiate the different streams included in the MPTS and may also be used with SPTS.

The satellite dishes 12a-12m may be configured to transmit the L band signals to a head-end unit or gateway server, such as the satellite gateway 14. In alternate, non-satellite embodiments, the head-end unit may be a cable television receiver, a high definition television receiver, or other video distribution system.

The satellite gateway 14 comprises a satellite tuning, demodulating, and demultiplexing module 16 and an internet protocol (IP) wrapper module 18. The module 16 may contain a plurality of receiving resources that may include tuners, demodulators, and demultiplexers to convert the modulated and multiplexed L band signals transmitted from the satellites 12a-12m into a plurality of data streams, (SPTS), each of which carries a service (e.g., television channel video, television channel audio, program guides, and so forth). In one embodiment, the module 16 is configured to receive particular L-band signals from a larger group of L-band signals that are received by satellite dishes 12a-12m. The module 16 then processes those signals to produce a new single program transport stream for all of the services received by the module 16. In an alternate embodiment, however, the module 16 may produce transport streams for either all or only a subset of the services received by the satellite dishes 12a-12m.

Although receiving resources described herein include circuits such as tuners, demodulators, and demultiplexers that perform tuning, demodulating, and demultiplexing functions, these receiving resources may also perform functions that separate or process incoming signals by other means including digital means, or may involve processing signals received in different time slots or on separate input cabling. Any of these functions may be performed by module 16.

The satellite tuning, demodulating, and demultiplexing module 16 may transmit the SPTS to the IP wrapper module 18. In one embodiment, the IP wrapper module 18 repackages the data within the SPTS into a plurality of IP packets suitable for transmission over the IP distribution network 20. For example, the IP wrapper module 18 may convert DirecTV protocol packets within the SPTS into IP packets. In addition, the IP wrapper module 18 may be configured to receive server requests from the STBs 22a-22n and to multicast (i.e., broadcast to one or more of the STBs 22a-22n over an IP address) the IP SPTS to those STBs 22a-22n that had requested the particular service.

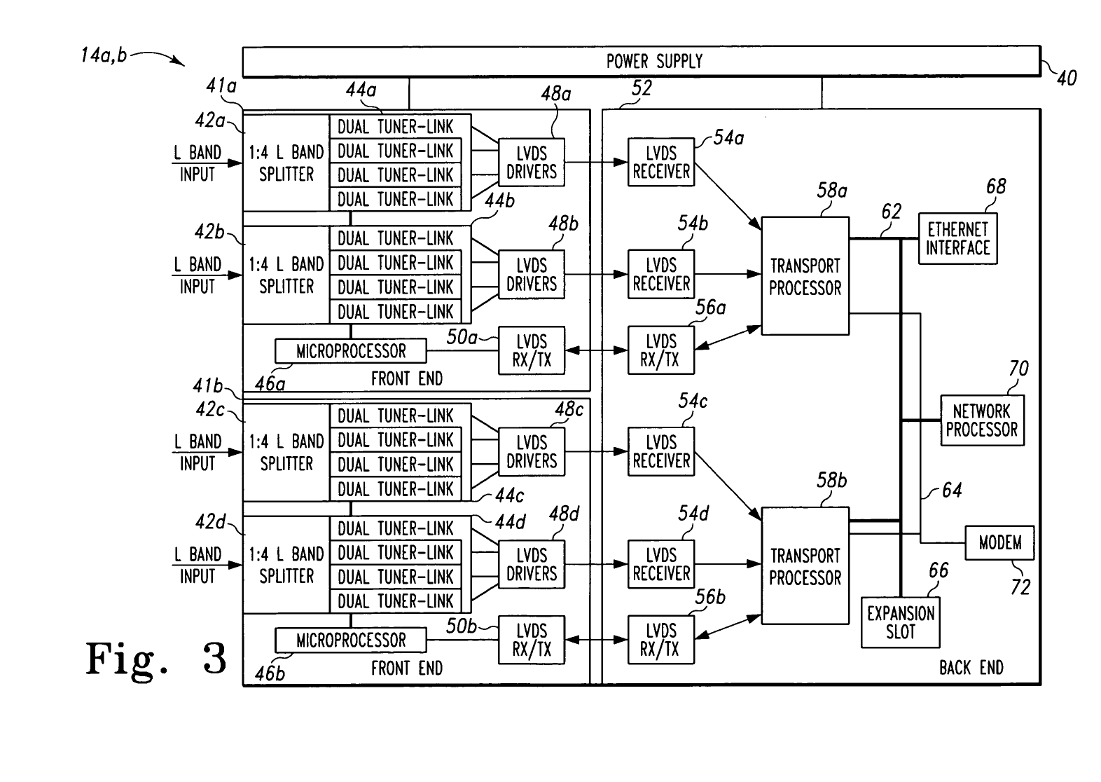

In an alternative embodiment, the IP wrapper module 18 may also be configured to multicast IP SPTS for services not requested by one of the STBs 22a-22n. For example, a particular receiving resource generates an output of five SPTS, of which only one of the SPTS is actually requested. However, an additional one of the SPTS is multicast IP for a reason relating to a requirement for supplying this particular service. It should be noted that the modules 16 and 18 are merely one exemplary embodiment of the satellite gateway 14. In alternate embodiments, such as the one described below in regard to FIGS. 2 and 3, the functions of the modules 16 and 18 may be redistributed or consolidated amongst a variety of suitable components or modules.

The IP distribution network 20 may include one or more routers, switches, modem, splitters, or bridges. For example, in one embodiment, the satellite gateway 14 may be coupled to a master distribution frame (“MDF”) that is coupled to an intermediate distribution frame (“IDF”) that is coupled to a coax to Ethernet bridge that is coupled to a router that is coupled to one or more of the STBs 22a-22n. In another embodiment, the IP distribution network 20 may be an MDF that is coupled to a Digital Subscriber Line Access Multiplexer (“DSLAM”) that is coupled to a DSL modem that is coupled to a router. In yet another embodiment, the IP distribution network may include a wireless network, such as 802.11 or WiMax network. In this type of embodiment, the STBs 22a-22n may include a wireless receiver configured to receive the multicast IP packets. Those of ordinary skill in the art will appreciate that the above-described embodiments are merely exemplary. As such in alternate embodiments, a large number of suitable forms of IP distribution networks may be employed in the system 10.

The IP distribution network 20 may be coupled to one or more STBs 22a-22n. The STBs 22a-22n may be any suitable type of video, audio, and/or other data receiver capable of receiving IP packets, such as the IP SPTS, over the IP distribution network 20. It will be appreciated the term STB, as used herein, may encompass not only devices that sit upon televisions. Rather the STBs 22a-22n may be any device or apparatus operating as an end user device in a dwelling, whether internal or external to a television, display, or computer, that can be configured to function as described herein—including, but not limited to a video components, computers, wireless telephones, or other forms video recorder. In one embodiment, the STBs 22a-22n may be a DirecTV receiver configured to receive services, such as video and/or audio, through an Ethernet port (amongst other inputs). In alternate embodiments, the STBs 22a-22n may be designed and/or configured to receive the multicast transmission over coaxial cable, twisted pair, copper wire, or through the air via a wireless standard, such as the I.E.E.E. 802.11 standard.

As discussed above, the system 10 may receive video, audio, and/or other data transmitted by satellites in space and process/convert this data for distribution over the IP distribution network 20. Turning now to FIG. 2, another embodiment of the exemplary satellite television over IP system 10 is shown. Each of the satellite dishes 12a-12c may be configured to receive signals from one or more of the orbiting satellites. Those of ordinary skill will appreciate that the satellites, and the signals that are transmitted from the satellites, are often referred to by the orbital slots in which the satellites reside. For example, the satellite dish 12a is configured to receive signals from a DirecTV satellite disposed in an orbital slot of 101 degrees. Likewise, the satellite dish 12b receives signals from a satellite disposed at 119 degrees, and the satellite dish 12c receives signals from a satellite disposed at orbital slot of 110 degrees. It will be appreciated that in alternate embodiments, the satellite dishes 12a-12c may receive signals from a plurality of other satellites disclosed in a variety of orbital slots, such as the 95 degree orbital slot. In addition, the satellite dishes 12a-12c may also be configured to receive polarized satellite signals. For example, the satellite dish 12a is configured to receive signals that are both left polarized (illustrated in the figure as “101 L”) and right polarized (illustrated as “101 R”).

As described above in regard to FIG. 1, the satellite dishes 12a-12c may receive satellite signals in the KU band and convert these signals into L band signals that are transmitted to the satellite gateway 14. In some embodiments, however, the L band signals produced by the satellite dishes 12a-12c may be merged into fewer signals or split into more signals prior to reaching the satellite gateway 14. For example, as illustrated in FIG. 2, L band signals from the satellite dishes 12b and 12c may be merged by a switch 24 into a single L band signal containing transport streams from both the satellite at 110 degrees and the left polarized streams from the satellite at 119 degrees.

System 10 may also include a plurality of 1:2 splitters 26a, 26b, 26c, and 26d to divide the L band signals transmitted from the satellite dishes 12a-12c into two L band signals, each of which include half of the services of the pre-split transport stream. In alternate embodiments, the 1:2 splitters 26a-26b may be omitted or integrated into the satellite gateways 14a and 14b.

The newly split L band signals may be transmitted from the 1:2 splitters 26a-26d into the satellite gateways 14a and 14b. The embodiment of the system 10 illustrated in FIG. 2 includes two of the satellite gateways 14a and 14b. In alternate embodiments, however, the system 10 may include any suitable number of satellite gateways 14. For example, in one embodiment, the system may include three satellite gateways 14.

The satellite gateways 14a and 14b may then further subdivide the L band signals and then tune, by using the receiving resources, to one or more services on the L band signal to produce one or more SPTS that may be repackaged into IP packets and multicast over the IP distribution network 20. In addition, one or more of the satellite gateways 14a, 14b may also be coupled to a public switch telephone network (“PSTN”) 28. Because the satellite gateways 14a, b are coupled to the PSTN 28, the STBs 22a-22n may be able to communicate with a satellite service provider through the IP distribution network 20 and the satellite gateways 14a, b. This functionality may advantageously eliminate the need to have each individual STBs 22a-22n coupled directly to the PSTN 28.

The IP distribution network 20 may also be coupled to an internet service provider (“ISP”) 30. In one embodiment, the IP distribution network 20 may be employed to provide internet services, such as high-speed data access, to the STBs 22a-22n and/or other suitable devices (not shown) that are coupled to the IP distribution network 20.

As described above, the satellite gateways 14a, b may be configured to receive the plurality of L band signals, to produce a plurality of SPTS, and to multicast requested SPTS over the IP distribution network 20. Referring now to FIG. 3, a block diagram of an exemplary satellite gateway 14 is shown. As illustrated, the satellite gateway 14a, b includes a power supply 40, two front-ends 41a and 41b and a back-end 52. The power supply 40 may be any one of a number of industry-standard AC or DC power supplies configurable to enable the front-ends 41a, b and the back-end 52 to perform the functions described below.

The satellite gateway 14a, b may also include two front-ends 41a, b. In one embodiment, each of the front-ends 41a, b may be configured to receive two L band signal inputs from the 1:2 splitters 26a-26d that were described above in regards to FIG. 2. For example, the front-end 41a may receive two L band signals from the 1:2 splitter 26a and the front-end 41b may receive two L band signals from the 1:2 splitter 26b. In one embodiment, each of the L band inputs into the front-end 41a, b includes eight or fewer services.

The front-ends 41a, b may then further sub-divide the L band inputs using 1:4 L band splitters 42a, 42b, 42c, and 42d. Once subdivided, the L band signals may pass into four banks 44a, 44b, 44c, and 44d of dual tuner links. Each of the dual tuner links within the banks 44a-44d may be configured to tune to two services within the L band signals received by that individual dual tuner link to produce SPTS. Each of the dual tuner links may then transmit the SPTS to one of the low-voltage differential signaling (“LVDS”) drivers 48a, 48b, 48c, and 48d. The LVDS drivers 48a-48d may be configured to amplify the transport signals for transmission to the back-end 52. In alternate embodiments, different forms of differential drivers and/or amplifiers may be employed in place of the LVDS drivers 48a-48d. Other embodiments may employ serialization of all of the transport signals together for routing to the back end 52.

As illustrated, the front-ends 41a, b may also include microprocessors 46a and 46b. In one embodiment, the microprocessors 46a, b may control and/or relay commands to the banks 44a-44d of dual tuner links and the 1:4 L band splitters 42a-42d. The microprocessors 46a, b may comprise ST10 microprocessors produced by ST Microelectronics. In other embodiments, a different processor may be used or the control may be derived from processors in the back end 52. The microprocessors 46a, b may be coupled to LVDS receiver and transmitter modules 50a and 50b. The LVDS receiver/transmitter modules 50a, b may facilitate communications between the microprocessors 46a, b and components on the back-end 52, as will be described further below.

Turning next to the back-end 52, the back-end 52 includes LVDS receivers 54a, 54b, 54c, and 54d, which are configured to receive transport stream signals such as SPTS or a MPTS, transmitted by the LVDS drivers 48a-48d. The back-end 52 also includes LVDS receiver/transmitter modules 56a and 56b which are configured to communicate with the LVDS receiver/transmitter modules 50a, b.

As illustrated, the LVDS receivers 54a-54d and the LVDS receiver/transmitters 56a, b are configured to communicate with controllers or transport processors 58a and 58b. In one embodiment, the transport processors 58a, b are configured to receive the SPTS produced by the dual tuner links in the front-ends 41a, b. For example the transport processors 58a, b may be configured to produce 16 SPTS. In general, the transport processors 58a, b may be capable of producing N SPTS where N is a number up to the number of individual program streams available at the input to the transport processors 58a, b. The transport processors 58a, b may also be configured to repacketize the SPTS into IP packets which can be multicast over the IP distribution network 20. For example, the transport processors 58a, b may repackage DirecTV protocol packets into IP protocol packets and then multicast these IP packets on an IP address to one or more of the STBs 22a-22n

The transport processors 58a, b may also be coupled to a bus 62, such as a 32 bit, 66 MHz peripheral component interconnect (“PCI”) bus. Through the bus 62, the transport processors 58a, b may communicate with another controller or network processor 70, an Ethernet interface 84, and/or an expansion slot 66. The network processor 70 may be configured to receive requests for services from the STBs 22a-22n and to direct the transport processors 58a, b to multicast the requested services. Additionally, the network processor 70 may also manage the operations and distribution of these services by receiving the requests from the STBs 22a-22n, maintaining a list of currently deployed services, and matching or allocating the receiving resources for providing these services to the STBs 22a-22n. In one embodiment, the network processor is an IXP425 network processor produced by Intel. While not illustrated, the network processor 70 may also be configured to transmit status data to a front panel of the satellite gateway 14a,b or to support debugging or monitoring of the satellite gateway 14a, b through debug ports.

As illustrated, the transport processors 58a, b may also be coupled to the Ethernet interface 68 via the bus 62. In one embodiment, the Ethernet interface 68 is a gigabit Ethernet interface that provides either a copper wire or fiber-optic interface to the IP distribution network 20. In other embodiments, other interfaces such as those used in digital home network applications may be used. In addition, the bus 62 may also be coupled to an expansion slot, such as a PCI expansion slot to enable the upgrade or expansion of the satellite gateway 14a, b.

The transport processors 58a, b may also be coupled to a host bus 64. In one embodiment, the host bus 64 is a 16-bit data bus that connects the transport processors 58a, b to a modem 72, which may be configured to communicate over the PSTN 28, as described above. In alternate embodiments, the modem 72 may also be coupled to the bus 62.

The network processor 70 may also contain a memory for storing information regarding various aspects of the operation of the gateway 14a, b. The memory may reside within the network processor 70 or may be located externally, although not shown. The memory may be used to store status information as well as tuning information for the receiving resources. Additionally the memory may be used to store information about which services each of the receiving resources can provide, and also maintain a list of services that are currently being provided to STBs 22a-22n.

One skilled in the art may recognize that transport processors 58a,b, network processor 70, and Microprocessors 46a, b may be included in one larger controller or processing unit capable of performing any of the control functions necessary for operation of the gateways 14a, b. Some or all of the control functions may also be distributed to other blocks and not affect the primary operation within gateways 14a, b.

The transport processors 58a, b may also manage the processing of the transport streams from the receiving resources. In one embodiment, the transport processors 58a, b may take each one the SPTS provided from a given receiving resource and produce one IP multicast stream containing all the SPTS together. In another embodiment, the processor may only take the SPTS requested by the STBs 22a-22n and produce a separate IP multicast stream for each one of the SPTS. It may also be possible to use a combination of both approaches. In conjunction, the network processor 70 may also maintain a list of all services provided for each of the resources currently in use, whether those services are actually currently requested or not. Additionally, the transport processors 58a, b may also contain a memory for providing storage of information such as the list of services and receiving resources.

As described above, the satellite gateways 14a,b may multicast services to the STBs 22a-22n over the IP distribution network 20. When the IP packets that make up a service reach one of the STBs 22a-22n, an Ethernet integrated circuit (“IC”) within the STBs 22a-22n may decode the IP packet to enable the STBs 22a-22n to play the service (a television channel, for example). These Ethernet ICs, however, may only be able to support a particular number of asynchronous data streams. The multicasting of video, audio, or other services described above, is one example of an asynchronous steam.

As described above, the Ethernet ICs within the STBs 22a-22n may only be designed to process a certain number of asynchronous streams at any given time. Accordingly asynchronous steams in excess of the Ethernet IC's capacity may be discarded or lost. For example, if the Ethernet ICs within one of the STBs 22a-22n has a capacity to handle four asynchronous steams at any given time, a fifth asynchronous stream may be dropped. If this fifth asynchronous stream is a multicast carrying a video service, the STB's display of that video service may be interrupted. For this reason, minimizing the number of asynchronous streams within the system 10 is desirable.

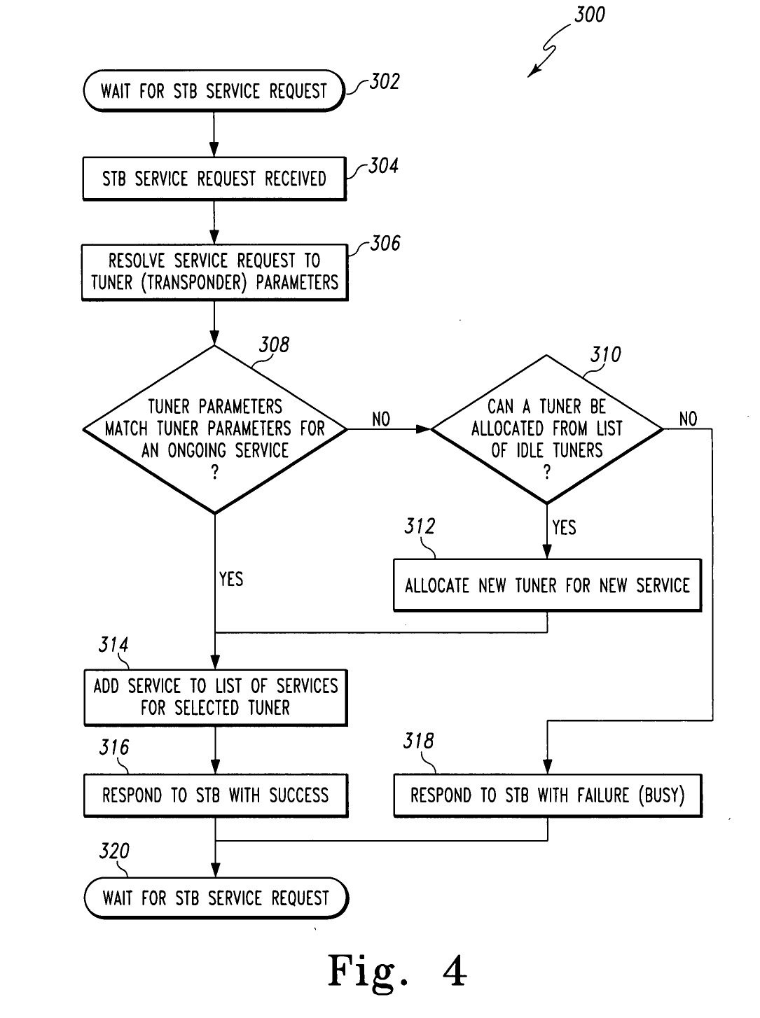

Turning now to FIG. 4, a method 300 for allocating resources from the gateway device to service the STBs is shown. The network processor 70, while performing other tasks in association with operation of the gateway 14, waits, at step 302, for a request initiated by one or more of the STBs 22a-22n. At step 304, a service request has been received at network processor 70 and, at step 306, the service request is processed by the network processor 70. The output of the processing in step 306 is a set of information that may include the parameters necessary to tune the correct channel to provide the service to the STBs 22a-22n. At step 308, a first comparison is made to determine if the currently requested parameters match the parameters already assigned and in use for ongoing service. These parameters may include, for instance, the tuning information for receiving the service from the satellite system through a receiving resource. This comparison may involve either comparing services currently being provided to STBs, or comparing a list of all the services that are available based on which L band transport signals that are currently tuned by the receiving resources. If the comparison returns a match, yielding a yes answer, then, at step 314, the current request of the STB 22a-22n is added to the list of services provided by the selected channel. In step 316, the network processor 70 provides a message to be sent back to the requesting STBs 22a-22n that the service request was a success.

In one embodiment, the network processor 70 provides a message by utilizing the capabilities in the Real Time Streaming Protocol (RTSP) used with Multicast IP data. The processor 70 modifies the data stream with a notification message to the STB 22a-22n that the STB 22a-22n should begin accepting packets associated with the particular multicast IP stream that contains the requested service. Utilizing RTSP and multicast IP represents only one possible method for notification and modification of the data stream that the server provides to the STBs 22a-22n. In another embodiment, after the network processor 70 determines that a match exists with regards to a specific parameter for a service, such as the necessary receiving resource, the network processor 70 may additionally compare whether the requested service that is being received by the receiving resource also matches a currently provided service. If it does match, then the network processor 70 may proceed with a notification through some means such as RTSP as noted earlier. If the service does not match then the network processor 70 may need to start up a new service, by creating a new data stream for an IP multicast through the transport processors 58a, b and notifying the requesting STBs 22a-22n that this service is now available by the method previously noted.

At step 308, if the comparison does not return a match, then, at step 310, processor 70 determines if a tuner is available to accommodate the service request. If a tuner is available, then the network processor 70, at step 312, provides the control signals to this available tuner and, at step 314, updates the service list with the new service and the new tuner. Then, at step 316, network processor 70 provides a message back to the STB 22a-22n.

Returning to step 310, if all tuners or receiving resources in the front ends 41a, b are currently allocated to existing service requests, then, at step 318, the network processor 70 provides a message to the STBs 22a-22n indicating that the service request has failed due to all resources being busy. Afterwards, at step 320, the network processor 70 enters into wait mode until a new service request is received.

Although this embodiment describes in detail a particular arrangement for utilizing a method for allocating receiving resources with an Ethernet or similar interface, other interfaces can utilize and benefit from a similar management method. For instance, in a system utilizing a co-axial cable interface, the resources and services can be managed to minimize the cost associated with expensive transmission equipment due to unnecessarily high operating bandwidth. It should be apparent to one skilled in the art that such a system of dynamically allocating receiving resources such as tuners is advantageous for use in a head end unit or gateway server.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A method of allocating receiving resources in a network, comprising:
receiving a request for a receiving resource;
comparing said requested receiving resource to a plurality of currently used receiving resources; and
establishing a shared use of one of said currently used receiving resources if said currently used receiving resource matches said requested receiving resource.

2. The method set forth in claim 1, further comprising the step of:
allocating an unused receiving resource if said requested receiving resource does not match one of said currently used receiving resources.

3. The method set forth in claim 1, wherein said receiving resource comprises:
a receiver for receiving a particular signal from a group of signals.

4. The method set forth in claim 1, wherein the step of receiving a request for a receiving resource further comprises:
receiving a request for a service wherein said service is to be provided as a data stream.

5. The method set forth in claim 4, wherein the step of establishing a shared use further comprises:
modifying said data stream to include an indicator of multiple requestors.

6. The method set forth in claim 1, wherein said request for a receiving resource is included in a request for service.

7. The method set forth in claim 1, further including the step of processing a request for service to determine said request for a receiving resource.

8. The method set forth in claim 1, wherein the step of comparing said requested receiving resource comprises comparing a parameter for tuning said requested receiving resource to a parameter for tuning said currently used receiving resource.

9. The method set forth in claim 8, wherein said parameter is a frequency.

10. The method set forth in claim 1, wherein the step of comparing said requested receiving resource comprises comparing a parameter for tuning said requested receiving resource to a parameter for tuning of each of the currently used receiving resources.

11. The method set forth in claim 10, wherein said parameter is a frequency.

12. The method set forth in claim 1, wherein the step of comparing said requested receiving resource further comprises comparing a parameter of a service associated with said requested received resource to a parameter of a currently provided service.

13. The method set forth in claim 12, wherein said parameter is a program identifier.

14. The method set forth in claim 1, wherein the step of comparing said requested receiving resource further comprises comparing a parameter of a service associated with said requested receiving resource to a parameter of each of a set of currently provided services.

15. The method set forth in claim 14, wherein said parameter is a program identifier.

16. The method set forth in claim 1, wherein said receiving resource comprises a tuner.

17. An apparatus, comprising:
a plurality of first devices for receiving a plurality of first signals and processing said first signals to generate second signals;
a plurality of second devices communicatively connected to said plurality of first devices, said plurality of second devices capable of processing said second signals to generate at least one third signal;
an interface communicatively connected to said plurality of second devices, wherein said interface is capable of passing said at least one third signal from said plurality of second devices and capable of receiving a request for service and passing said request for service to said plurality of second devices; and
a controller communicatively connected to said plurality of first devices, said plurality of second devices, and interface such that said controller manages the allocation of said plurality of first devices based on receiving said request for service from said interface.

18. The apparatus set forth in claim 17, wherein said plurality of first devices for receiving said plurality of first signals are receivers for receiving particular signals from a group of signals.

19. The plurality of receiving resources set forth in claim 18, wherein said receivers are tuners.

20. The apparatus set forth in claim 17, wherein said first signals are L-band signals.

21. The apparatus set forth in claim 17, wherein said second signals are transport streams.

22. The apparatus set forth in claim 17, wherein said interface is a device for transmitting a data stream using internet protocol.

23. The apparatus set forth in claim 17, wherein said interface is communicatively connected to a plurality of end user devices.

24. The apparatus set forth in claim 23 wherein said end user devices are set top boxes.

25. The apparatus set forth in claim 17, wherein said controller manages the allocation of said plurality of first devices based on receiving said request for service by receiving a request for service including a request for one of said plurality of first devices, comparing said request for one of said plurality of first devices to said plurality of first devices that are currently used, and establishing a shared use of one of said plurality of first devices if one of said plurality of first devices currently used matches said request for one of said plurality of first devices.

26. The controller of claim 25, wherein said controller compares said request for one of said plurality of first devices by comparing a parameter of tuning of said request to a parameter for tuning one of said plurality of first devices currently used.

27. The controller of claim 25, wherein said controller compares said request for one of said plurality of first devices by comparing a parameter for tuning of said request to a parameter for tuning of each of said plurality of first devices currently used.

28. The controller of claim 25, wherein said controller compares said request for service by comparing a parameter of said request for service to a parameter of one of said plurality of second signals currently passed from said plurality of first devices.

29. The controller of claim 25, wherein said controller compares said request for service by comparing a parameter of said request for service to a parameter of each of said plurality of second signals currently passed from said plurality of first devices.

30. The apparatus set forth in claim 17, wherein said controller manages the allocation of said plurality of first devices based on receiving said request for service by determining a request for one of said plurality of first devices from said request for service, comparing said request for one of said plurality of first devices to said plurality of first devices that are currently used, and establishing a shared use of one of said plurality of first devices if one of said plurality of first devices currently used matches said request for one of said plurality of first devices.

31. A gateway apparatus, comprising:
means for receiving a request for a receiving resource;
means for comparing said requested receiving resource to a plurality of currently used receiving resources; and
means for establishing a shared use of one of said currently used receiving resources if said currently used receiving resource matches said requested receiving resource.
